(19) United States
(12) Patent Application Publication
(10) Pub. No.: US 2010/0083908 A1
(43) Pub. Date: Apr. 8, 2010

(54) CALF CHUTE TAILGATE

(76) Inventors: Ken Brown, Mt. Pleasant, TX (US); Terry Wood, Mt. Pleasant, TX (US)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(21) Appl. No.: 12/573,270

(22) Filed: Oct. 5, 2009

Related U.S. Application Data
(60) Provisional application No. 61/102,567, filed on Oct. 3, 2008.

(51) Int. Cl. A01K 15/04

(52) U.S. Cl. 119/422; 119/751

(57) ABSTRACT

A calf chute tailgate particularly suited for use in calf roping competitions is disclosed. The tailgate has a pair of upright bars that are mounted to the entry of the calf chute using a pair of four-bar linkages so that during opening and closing of the gate the bars retain their upright orientation resulting a calf chute gate that is fully open across its full height permitting easy access to the chute by calves of any size and shape.

### RELATED APPLICATION

This application claims priority to U.S. patent application Ser. No. 61/102,567, filed Oct. 3, 2008, and incorporated herein in its entirety by this reference.

### BACKGROUND OF THE INVENTION

The invention relates generally to cattle chutes and, more specifically, to a chute for calves and especially a control chute for calves used in rodeo roping competitions.

There is a need for a chute to contain calves for the purpose of competition roping. Initial efforts at a solution were made by attempting to redesign a chute based on a known steer roping chute of Priefert Manufacturing. The thought was to take the steer chute and copy it, but shrink it to a smaller scale that would fit the size range of calves that are used in competition roping. The original redesign resulted the correct overall size for the chute, but the entry gate, or tailgate, was of the same design as that of the original steer chute where the bottom of the split entry gate was pivoted in the middle, thereby providing an entry gate that a V-shape. The tailgate opened to the full width at the top but not at the bottom. This V-shape is not a problem for steers because they are generally lanky and the V-shape fits well with their body profile. The problem with an entry gate having a V-shape in a calf chute is that calves can range from small and thin to small and fat or large and fat or large and thin. The small and fat and large and fat calves had problems entering through this type of entry gate. Therefore, there is a need for an entry gate that opens to substantially the same width at both the top and bottom.

Other tailgates or entry gates on the market are single panel slide out gates that slide on rollers or cam over on straps located totally outside of the entry area of the chute. These are not well received in the market because of the perceived danger for a contestant or their horse when this panel is protruding out fifteen to twenty inches from the chute. Another type of tailgate is a panel type that has rollers at the four corners that roll in tracks of channel iron. These either roll straight out away from the chute or vertically up. When they are used in the vertical position, they typically use a rope and pulley, with the pulley attached to a fixed crossbar above and the panel is lifted up out of the way of the animal until the animal goes past and it is dropped behind. These are not well received either because of the weight of the panel and the problem that the rollers generally bind in the track after a few years of use.

### SUMMARY OF THE INVENTION

The calf roping chute tailgate of the present invention is an assembly piece of the calf roping chute. The roping chute is used in competition calf roping, general recreation, and practice of the sport. Steer roping chutes have been around for years, and are used some in calf roping, but there is a need for a smaller chute to contain smaller animals in a more suitable manner for the competitors. The tailgate operates to slide open both sides of the gate substantially evenly from along the whole height of the gate using a pair of four-bar linkages so that the gate is open full width and both the top and bottom. The full width feature of the tailgate on the calf roping chute has improved the ease of use of the calf chute for the operator and increased the comfort for the calf because the operation is easy and light and the calf can enter the chute without any obstructions.

### BRIEF DESCRIPTION OF THE DRAWINGS

FIG. 1 is a front left isometric view of a cattle chute that incorporates a preferred embodiment of the present invention.

FIG. 2 is a back left isometric view of the cattle chute.

FIG. 3 is a back view of a closed tailgate of a preferred embodiment of the present invention.

FIG. 4 is a front view of the closed tailgate.

FIG. 5 is a back isometric view of the closed tailgate.

FIG. 6 is a front isometric view of the closed tailgate.

FIG. 7 is a back isometric view of the tailgate in a halfway open position.

FIG. 8 is a back isometric view of the tailgate in a fully open position.

FIG. 9 is a left view of the chute.

### DESCRIPTION OF THE INVENTION

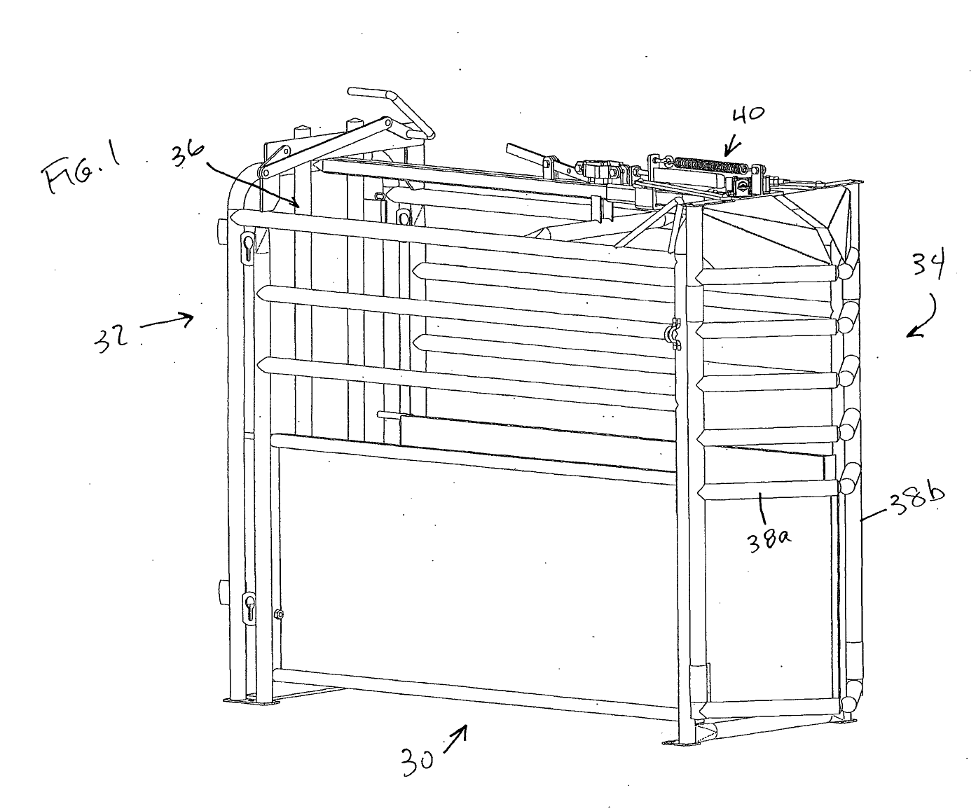

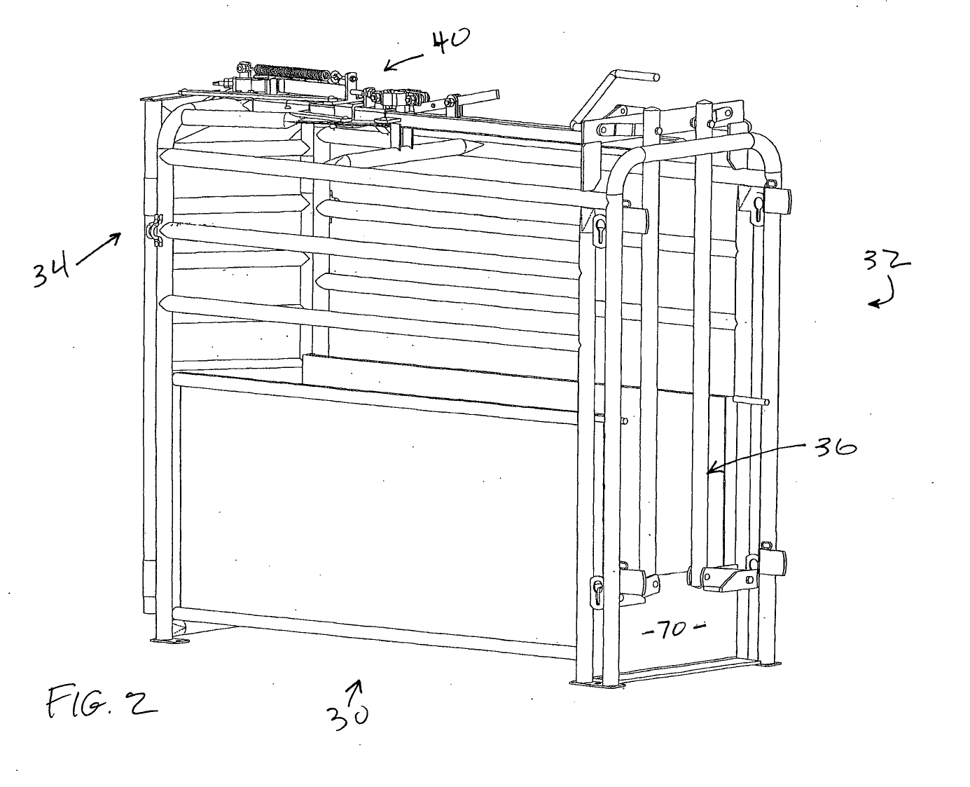

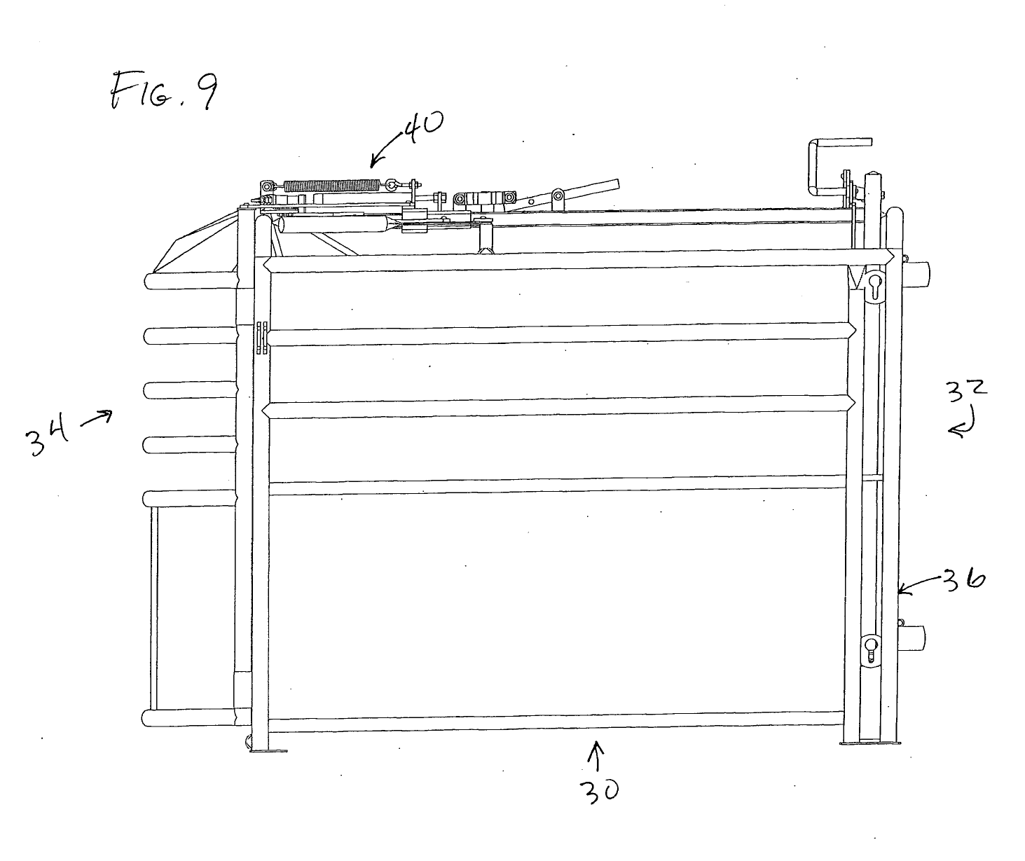

Referring to FIGS. 1-2 and 9 there is illustrated generally at 30 a cattle chute which incorporates a preferred embodiment of the present invention. The chute includes an entry end 32 and an exit end 34. A tailgate 36 controls access to the chute 30 at the entry end 32. A calf in the chute 32 exits through a pair of doors 38 that are controlled by a spring-loaded mechanism 40.

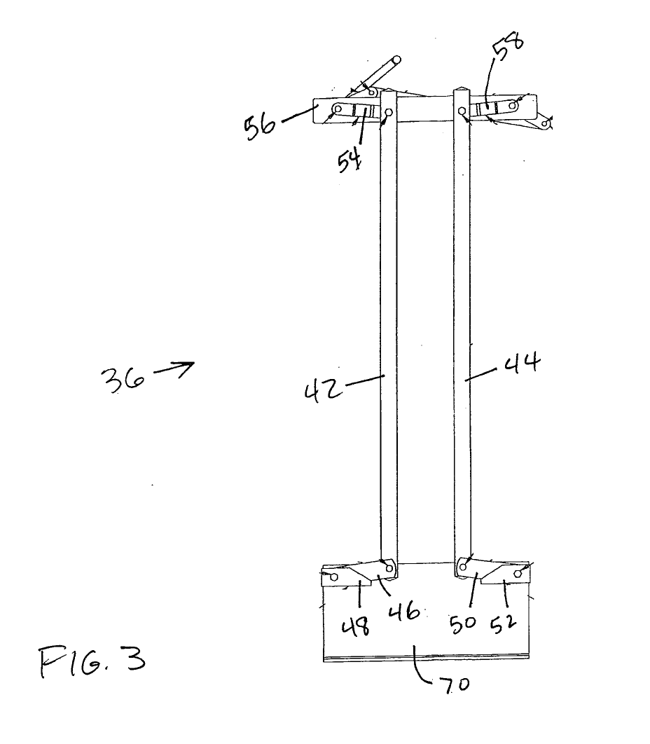

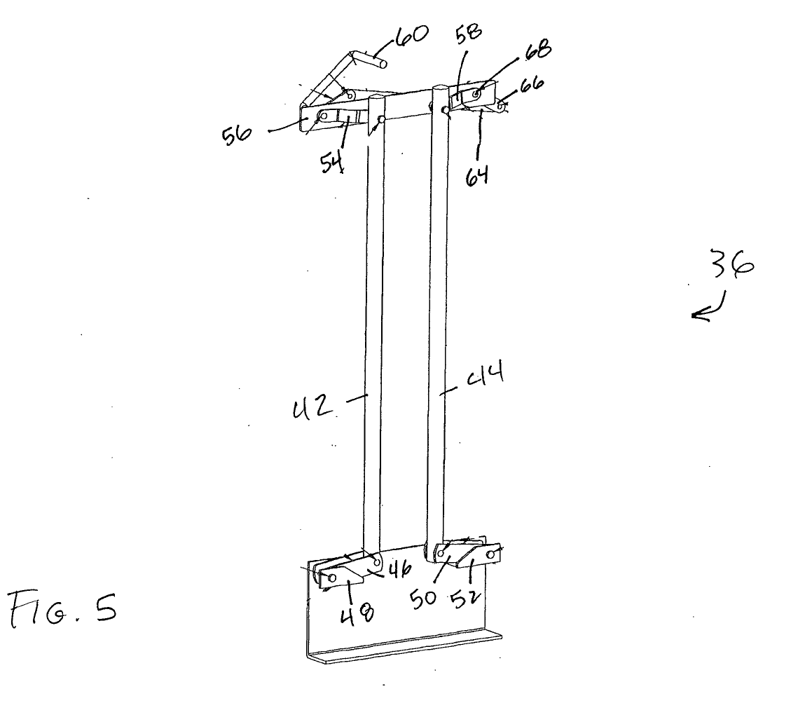

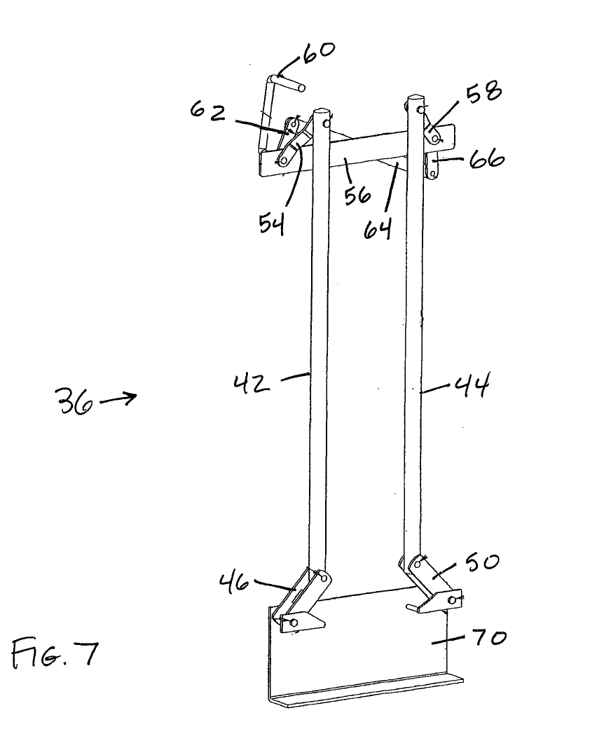

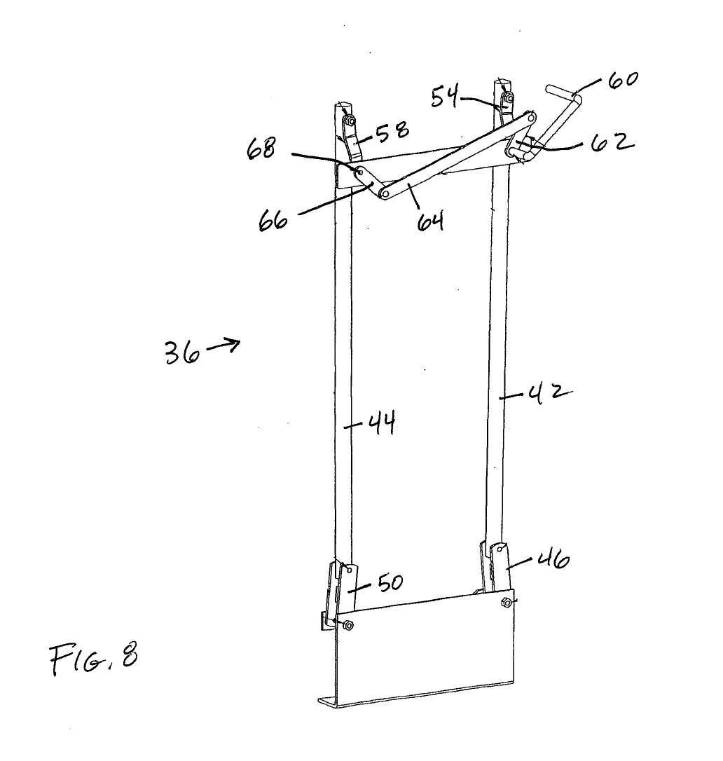

The tailgate 36 is illustrated in more detail in FIGS. 3-8. It includes a pair of vertical pipes 42 and 44 that are moved between a closed position (FIGS. 3-6) and an open position (FIG. 8), passing through an intermediate position (FIG. 7). The lower end portion of pipe 42 is mounted for pivotal movement on a strap 46 that is in turn mounted for pivotal movement on a stop block 48 affixed to a base member 70 of the cattle chute 30. Similarly, the lower end portion of pipe 44 is mounted for pivotal movement on a strap 50 that is in turn mounted for pivotal movement on a stop block 52. The upper end portion of pipe 42 is mounted for pivotal movement on a lever 54 that is in turn mounted for pivotal movement on an upper frame member 56. Similarly, the upper end portion of pipe 44 is mounted for pivotal movement on a lever 58 that is in turn mounted for pivotal movement on the upper frame member 56.

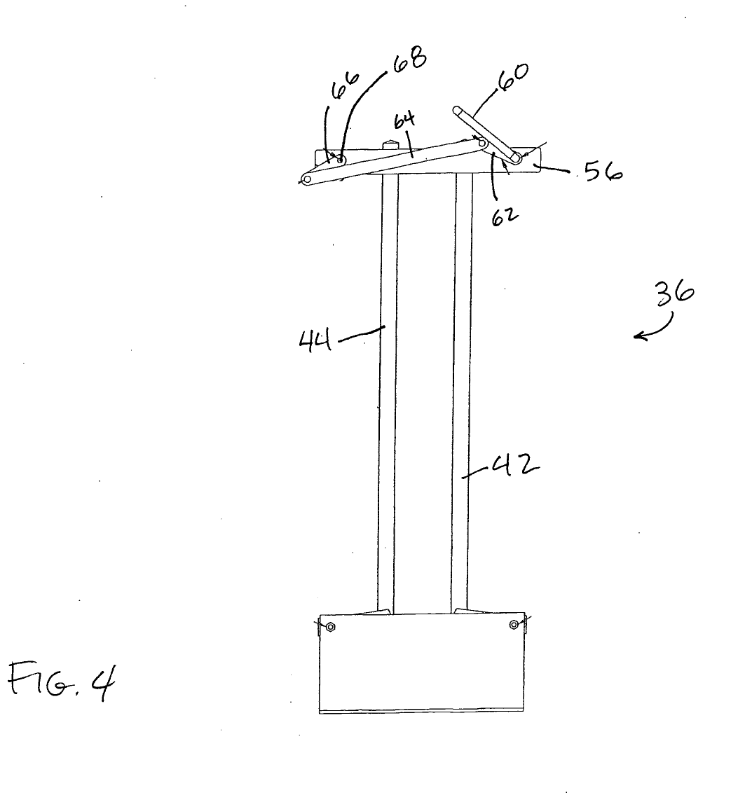

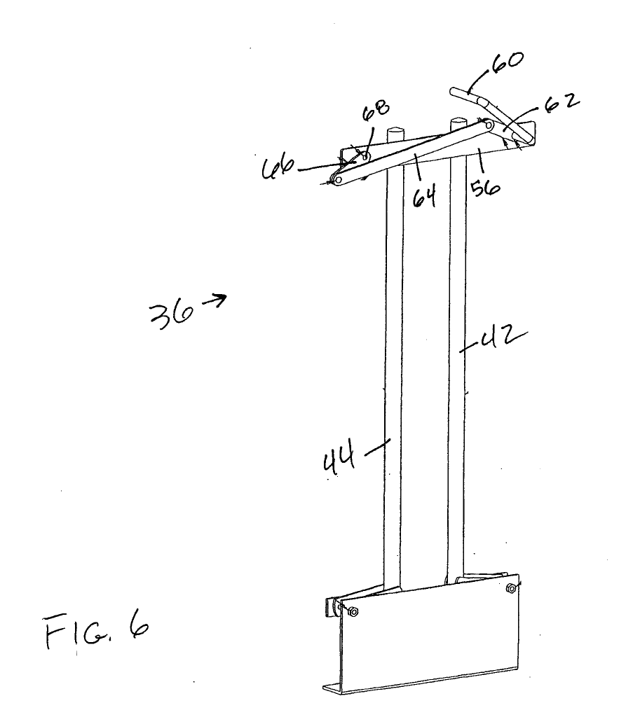

Referring to FIG. 6, a handle 60 is a bent rod that is welded to a lever 62 and to the lever 54 (FIG. 3) passing through a hole in the upper frame member 56, with the result that pivotal movement of the handle 60 will pivot both of levers 62 and 54. Lever 62 is pivotally attached to a first end of lever 64. At the other side of the upper frame member 56, a rod 68 passes through a hole in the upper frame member 56 and is welded at one end to lever 58 (FIG. 3) and at the other end to a first end of lever 66. The second, opposite end of lever 66 is pivotally attached to a second end of lever 64. Accordingly, movement of handle 60 outwardly (in the clockwise direction in FIG. 4) will lift and slide the pipes 42 and 44 away from each other (see FIG. 7) thereby opening the tailgate 36 from the closed position (FIGS. 3-6) through the halfway open position (FIG. 7), to the fully open position (FIG. 8). The tailgate 36 is held in the open position by cam or over center action, as illustrated in FIG. 8 where the rotating levers 54 and 58 have pivoted past their respective pivot points. From the open position (FIG. 8), the tailgate 36 can be closed by movement of the handle 60 to its inward positions (FIGS. 3-7).

In operation, when handle 60 is pulled, lever 62 pulls lever 64, which pulls on lever 66, which rotates at pivot 68, rotating lever 58, lifting pipe 44, which lifts rotates strap 50. Simultaneously, the handle 60 pivots lever 54, lifting pipe 42, pivoting strap 46. To close the tailgate 36, the operator pushes the handle 60 inward and the reverse procedure causes the pipes 42 and 44 to return to the center where straps 46 and 50 rest on the stop blocks 48 and 52.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

We claim:

1. A gate for an animal control chute, comprising:
(a) a base member of the chute;
(b) an upper frame member of the chute;
(c) a first upright gate member pivotally interconnected at a first side to the base member and the upper frame member by a lower and an upper link, respectively, to create a four-bar linkage;
(d) a second upright gate member pivotally interconnected at a second side to the base member and the upper frame member by a lower and an upper link, respectively, to create a four-bar linkage; and
(e) a handle interconnected to the upper links to lift and move the gate members away from each other while maintaining the gate members in their original, upright orientation.

2. A gate for an animal control chute, comprising:
(a) a first vertical pipe pivotally mounted at its lower end on a first lever for movement between a central, closed position and an outer, open position;
(b) a second vertical pipe pivotally mounted at its lower end on a second lever for movement between a central, closed position and an outer, open position;
(c) a third lever pivotally attached to an upper end of the first pipe;
(d) a fourth lever pivotally attached to an upper end of the second pipe; and
(e) a handle interconnected to the third and fourth levers to lift and move the pipes away from each other while maintaining the pipes in their vertical orientation.
